(19) United States
(12) Patent Application Publication
(10) Pub. No.: US 2017/0017960 A1
(43) Pub. Date: Jan. 19, 2017

(54) CONDITIONALLY PURCHASING CLOUD SERVICES

(71) Applicant: HEWLETT PACKARD ENTERPRISE DEVELOPMENT LP, Houston, TX (US)

(72) Inventor: Senthil Kumar Subramaniam, Chennai (IN)

(21) Appl. No.: 15/119,160

(22) PCT Filed: Apr. 7, 2014
(86) PCT No.: PCT/US2014/033136

§ 371 Date: Aug. 16, 2016

(51) Int. Cl. G06Q 20/40; G06F 3/0482; G06Q 30/06

(52) U.S. Cl. CPC G06Q 20/401; G06Q 30/0611; G06F 3/0482

(57) ABSTRACT

Conditionally purchasing cloud services can include providing a conditional purchase offer to a cloud service provider and receiving, from the cloud service provider, a response to the conditional purchase offer.

### BACKGROUND

A cloud service generally refers to a service or service hosting construct that allows end recipient computer systems, e.g., thin clients, portable computers, smart phones, desktop computers, other applications, services or systems, to access a pool of hosted computing, networking and network resources, storage, and/or storage resources, e.g., the cloud resources exposed over a network such as the Internet, for example. In this manner, a hosting company, such as a cloud service provider, may, for example, provide cloud services that may include software as a service (SaaS) by hosting applications, infrastructure as service (IaaS) by hosting equipment (servers, storage components, network components, etc.), or a platform as a service (PaaS) by hosting a comprehensive computing platform (operating system, middleware, data bases, associated lifecycle management functions such as auto-scaling infrastructure, etc.), among other cloud services.

### BRIEF DESCRIPTION OF THE DRAWINGS

FIG. 1 illustrates an example of an environment in which various example processes can be implemented for conditionally purchasing cloud services according to the present disclosure.

FIG. 2 illustrates an example of a flow diagram for conditionally purchasing cloud services in accordance with the present disclosure.

FIG. 3 illustrates a diagram of an example of a system for conditional conditionally purchasing cloud services according to the present disclosure.

FIG. 4 illustrates a diagram of an example of a computing device for conditionally purchasing cloud services according to the present disclosure.

FIG. 5 illustrates a flow diagram of an example of a method for conditionally purchasing cloud services according to the present disclosure.

### DETAILED DESCRIPTION

Cloud services are widely used by a variety of customers including enterprise operations and/or individual consumers of cloud services, among other customers. A hosting company, such as a cloud service provider, may, for example, provide cloud services that may include software as a service (SaaS) by hosting applications, infrastructure as service (IaaS) by hosting equipment (servers, storage components, network components, etc.), and/or a platform as a service (PaaS) by hosting a comprehensive computing platform (operating system, middleware, data bases, associated lifecycle management functions such as auto-scaling infrastructure, etc.), among other cloud services. Cloud services may include internet based cloud services that may be capable of providing various functionalities. For example, a cloud service can allow a customer (e.g., enterprise organization) to do business and/or perform a task without worrying about underlying technology and/or IT infrastructure.

Customers (e.g., perspective customers) of cloud services may be notified of an existence of a cloud service and/or information associated with a cloud service by a cloud broker. A cloud broker refers to a third-party individual or business that acts as an intermediary between the customer of a cloud service and a cloud service provider(s) of the cloud service. That is, cloud brokers may facilitate provisioning and consumption of cloud services. For example, a cloud broker may enable a customer to purchase cloud services in a manner such that the customer does not have to identify existence of a particular cloud service but rather the cloud service is communicated to the customer by the cloud broker. However, cloud brokers may be limited to communicating prices that have been set (e.g., published) by a cloud service provider to the customer. Consequently, customers may have to browse through various cloud service providers and/or cloud services communicated by a cloud broker in the hope of identifying a cloud service that satisfies a desired price and/or other criteria that are specific to the customer/requested cloud service. Such customer intensive browsing through various cloud services and/or cloud service providers can be difficult, costly (e.g., time-consuming), and/or ineffective, among other difficulties.

In contrast, examples of the present disclosure include methods, systems, and computer-readable and executable instructions for conditionally purchasing cloud services. Conditionally purchasing cloud services can, for example, include providing a conditional purchase offer to a cloud service provider and receiving, from the cloud service provider, a response to the conditional purchase offer. Advantageously, such conditional purchasing of cloud services can facilitate a customer to set an offer price and/or other conditions associated with a cloud service, among other advantages. For example, a conditional purchase offer including an offer price can be provided to a cloud broker which can automatically provide the conditional purchase offer to various cloud service providers and/or receive responses such as acceptances and/or rejections of the conditional purchase offer from the cloud service providers.

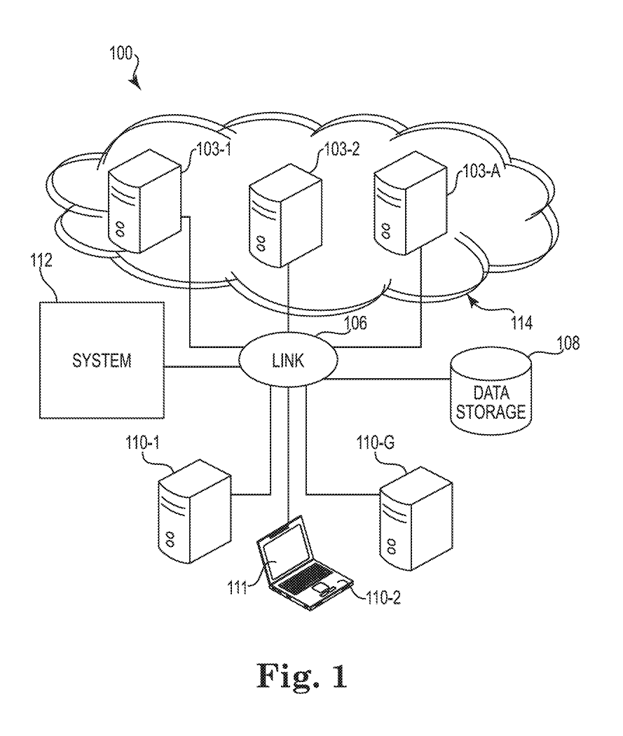

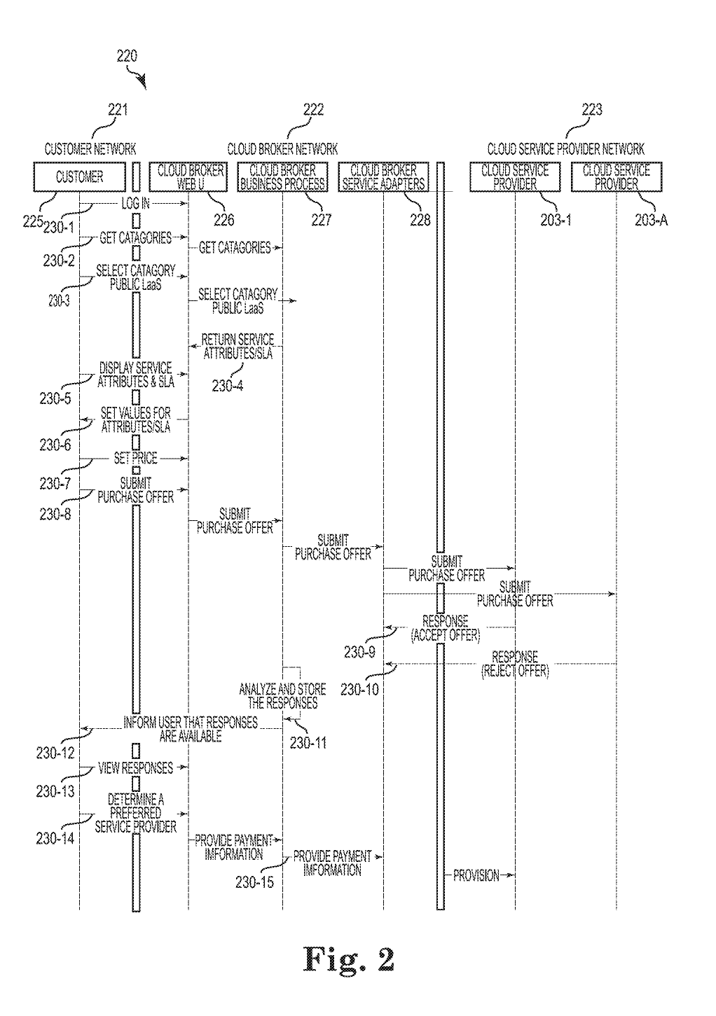

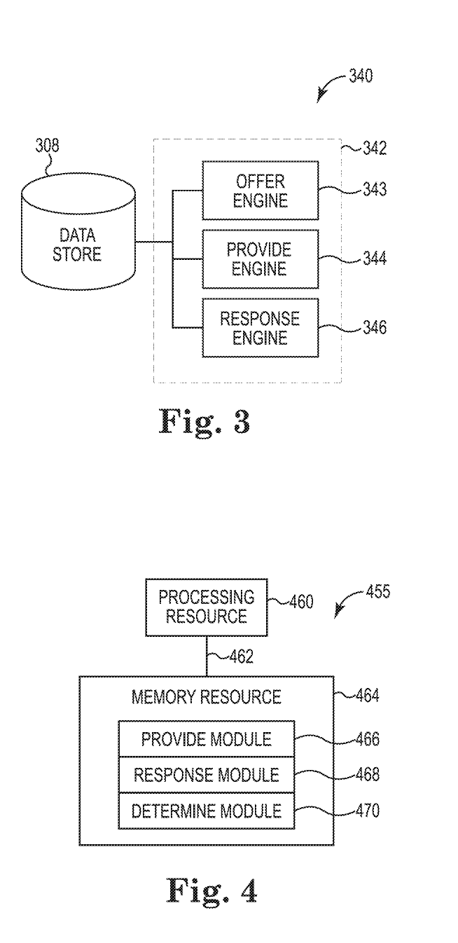

FIG. 1 illustrates an example of an environment 100 in which various example processes can be implemented for conditionally purchasing cloud services according to the present disclosure. The environment 100 is shown to include a system 112 for conditionally purchasing cloud services, cloud service providers 103-1, 103-2, . . . , 103-A, workstations 110-1, 110-2, . . . , 110-G, a data store 108, a link 106, and a cloud-based computing system 114. The cloud service providers 103-1, . . . , 103-A can be analogous to the cloud service providers 203-1, . . . , 203-A discussed with respect to FIG. 2. The data store 108 can be analogous to the data store 308 discussed with respect to FIG. 3.

The system 112 for conditionally purchasing cloud services can represent different combinations of hardware or hardware and instructions to conditionally purchase cloud services. The system 112 for conditionally purchasing cloud services can include a computing device (not shown), for instance, computing device 455 as discussed with respect to FIG. 4. The system 112 can include engines analogous to engines described with respect to FIG. 3. For example, the system 112 can include an offer engine, a provide engine, and a response engine, as described herein with respect to FIG. 3, among other engines.

Cloud services and/or cloud service providers 103-1, . . . , 103-A, among other items, can be viewed using a workstation, such as workstations 110-1, . . . , 110-G. Workstations 110-1, . . . , 110-G represent devices that can generate/receive electronic data having browsers and/or other applications to communicate such data and/or facilitate viewing of cloud services and/or cloud service providers, among other abilities. Examples of workstations 110-1, . . . , 110-G include desktop/laptop computers, mobile phones, and/or servers, among other devices suitable for conditionally purchasing cloud services.

In various examples, the workstations 110-1, . . . , 110-G and/or data store(s) 108 can be separate and distinct from the cloud-based computing system 114. As described herein, being separate and distinct refers to an environment being physically separate and/or having separate network resources (e.g., network resources to monitor traffic) with respect to each other. In this manner, a workstation can receive (e.g., remotely receive) traffic from the cloud-based computing system 114 (e.g., from cloud service providers 103-1, . . . , 103-A). However, the present disclosure is not so limited. That is, the workstations 110-1, . . . , 110-G and/or data store(s) 108 can, in some examples, be included the cloud-based computing system 114 and/or the link 106. Regardless, receipt of information (e.g., responses and/or cloud services) from the cloud service provider 103-1, . . . , 103-A by the link 106 and/or workstations 110-1, . . . , 110-G can promote conditionally purchasing cloud services from the cloud service providers 103-1, . . . , 103-A, as described herein.

The workstations 110-1, . . . , 110-G can include an electronic display such as a graphical user interface (GUI) 111. A user interface (UI) can include hardware components and/or computer-readable instruction components. For instance, hardware components can include input components (e.g., a mouse, a touch screen, and a keyboard) and/or output components (e.g., a display). An example UI can include a GUI. A GUI can, for example, electronically represent a cloud service (e.g., identifying information such as a name, a price, attributes, and/or parameters, among other items associated with a particular cloud service) and/or provide an indication (electronic representation) of a response associated with a particular cloud service (e.g., a status identifying that a conditional offer has been submitted and/or that a response has or has not been received in response to the conditional offer), among other electronic representations.

Such an indication can include, for example, an indication of a cloud service name, an anticipated (e.g., average) amount of up-time for the cloud service, among other indications. Statuses can correspond to responses, such as those described herein. For example, a response can have a corresponding status associated therewith (e.g., information that identifies a particular status) provided as an indicator. In some examples, an indicator can be displayed by a UI of a workstation. For example, the indicator can be a numeric indicator, a textual indicator, a pop-up window, and/or a particular color (e.g., display of the color green to indicate a conditional purchase offer has an “accepted” status), among other possible types of indicators. Conversely, a red color can be displayed to indicate a conditional purchase offer has been rejected. Such displays can facilitate interactions between a user and a computer (e.g., allows a user to interact with a computer using images and/or text).

Link 106 (e.g., a network) represents a cable, wireless, fiber optic, and/or remote connection via a telecommunication link, an infrared link, a radio frequency link, and/or other connectors or systems that provide electronic communication. That is, the link 106 can, for example, include a link to an intranet, the Internet, or a combination of both, among other communication interfaces. The link 106 can also include intermediate proxies, for example, an intermediate proxy server, routers, switches, load balancers, and the like. However, the present disclosure is not so limited. That is, link 106 can represent a cloud broker, as described herein, and/or can represent a physical connection between the cloud service providers 103-1, . . . , 103-A and the workstations 110-1, . . . , 110-G to communicate instructions between the workstations 110-1, . . . , 110-G, the intermediate server, the application server, the cloud service providers 103-1, . . . , 103-A, and/or the data store 108.

The cloud-based computing system 114 refers to computational resources that can be linked through the use of computer networks. Allocation of the computation resources can be varied to meet changing demands, such as changes in a total number of customers and customer used cloud services, upon the cloud-based computing system 114. The cloud-based computing system 114 can include a public cloud system, a private cloud system, and/or a hybrid cloud system. For example, a public cloud system and a private cloud system can include and/or constitute a hybrid system.

Each cloud-based computing system 114 can have a respective workstation(s) and/or cloud service provider(s) corresponding thereto. For example, a portion of the cloud-based computing system 114 can be provided by a cloud service provider, such as cloud service provider 103-1, and another portion of the cloud-based computing system 114 can be provided by another cloud service provider, such as cloud service provider 103-2. In this manner a number of cloud service providers 103-1, . . . , 103-A can provide the cloud-based computing system 114 and/or a number of cloud based services via the cloud-based computing system 114.

A public cloud system can include a cloud service provider that makes resources (e.g., applications and storage) available to the public over the Internet. A public cloud system can be free or offered for a fee, for example.

A private cloud system can include a computing environment that provides hosted services to a limited number of people behind a firewall. For example, a private cloud can include an Enterprise Resource Planning (ERP) system (not shown), a number of computing devices (e.g., databases), and virtualization (e.g., virtual machines) (not shown), among others. For instance, a private cloud system can include a computing environment that provides hosted services to a limited number of the plurality of nodes (e.g., computer) behind a firewall. The ERP, for example, can integrate internal and external management information across an entire enterprise and/or organization. The public cloud system and the private cloud system can be bound together, for example, through an application in the public cloud system and the ERP in the private cloud system.

A hybrid cloud (e.g., traditional/cloud IT environment), for example, can include a mix of traditional server systems, private cloud systems, public cloud systems, and/or dynamic cloud services. For instance, a hybrid cloud/traditional IT environment can involve interdependencies between physically and logically separated services including multiple systems. A hybrid cloud/traditional IT environment, for example, can include a number of clouds (e.g., two or more clouds) that can remain unique entities but can be bound together.

FIG. 2 illustrates an example of a flow diagram for conditionally purchasing cloud services in accordance with the present disclosure. The flow diagram 220 is designed to be used in entire environment such as the environment described in FIG. 1. For example, the flow diagram 220 can include: a customer network 221 that can include a customer 225 and workstations (e.g., workstations 110-1, . . . , 110-G); a cloud broker(s) network 222 (e.g., a link) including a cloud broker web interface 226, a cloud broker business process 227, and a plurality of cloud broker service adaptors 228; and a cloud service provider network 223 including a plurality of cloud service providers 203-1, . . . , 203-A and/or a cloud-based computing system (e.g., cloud based computing system 114 as described with respect to FIG. 1). The customer can be a consumer (e.g., perspective consumer) of a cloud service. The cloud broker interface can include a GUI, such as those described herein, and/or can include information communicated to a GUI associated with a customer (e.g., a GUI included in a workstation such as workstation 103-1). A cloud broker business process 227 refers to a collection of related, structured activities or phases that can communicate a cloud service to a particular customer or customers. That is, the cloud broker business process 227 can include a plurality of phases, such as some or all of those described with respect to FIG. 2. The cloud broker network 222 and/or the cloud service provider network 223 can include application programming interfaces (API)s to promote communication between the cloud broker network 222, the cloud service provider network 223, and/or a customer 225.

While certain aspects are mentioned in regard to a particular network (e.g., a customer network) it is notable that all the networks are interrelated (passing information to and from one to another) and that discussion of a particular element in context of a particular network should not be deemed to limit the element to the network unless specified otherwise. For instance, some/all of a conditional purchase offer can be transferred from one network to the next in an order suitable to promote conditionally purchasing cloud services, as described herein.

During phase 230-1 a customer 225 can login to a workstation (e.g., workstation 103-1 as described with respect to FIG. 1). Logging in during phase 230-1 can include entering information that identifies a customer to a workstation, among other information. A customer can be provided a display of a plurality of categories at phase 230-2. Examples of categories of cloud services can include SaaS, IaaS, and/or PaaS, among other categories. During phase 230-3 a customer can select a particular category of the plurality of categories, for instance, selecting from those displayed as a result of phase 230-2.

A cloud broker network 222, for instance, a cloud broker business process can receive a selection of a cloud service, such as a selection from 230-3, and return service attributes and/or service level agreement (SLA) parameters that can be associated with the cloud service selected. During phase 230-5, service attributes and/or SLA parameters can be displayed. Service attributes and/or SLA parameters can be selected and corresponding values can be set for each of the service attributes and/or SLA parameters at 230-6. For example, an SLA parameter, such as an uptime parameter can be selected and a value (e.g., 97% uptime) can be set for the selected SLA parameters. Similarly, services attributes, for example, a number of total users of a cloud service, an average and/or maximum storage size per user, an encryption policy of the cloud service, etc. can be selected and values can be set accordingly. The service attributes and/or SLA parameters selected can be indicated as mandatory (e.g., mandatory to satisfy by a cloud service provider providing an acceptance responsive to the conditional purchase offer) or as elective (e.g., not mandatory to by a cloud service provider providing an acceptance responsive to the conditional purchase offer). For example, a plurality of service attributes can include mandatory service attributes and/or elective service attributes.

During phase 230-7 an offer price can be set. An offer price corresponds to a maximum amount of money a customer is willing to pay for a particular cloud service (e.g., for the particular service attributes and/or SLA parameters selected/values corresponding thereto). An offer price can be comparatively lower than an advertised price for the cloud service. At phase 230-8 a purchase offer can be submitted to a cloud service provider and/or a plurality of cloud service providers. The purchase offer can include the selected category of cloud service, the selected service attributes (e.g., selected service attributes and values corresponding thereto), the selected SLA parameters (e.g., selected SLA parameters and values corresponding thereto), and/or a purchase price. The purchase offer can be submitted to the cloud service provider network 223 via the cloud broker network 222.

A response to the conditional purchase offer can be sent by a cloud service provider 203-1, . . . , 203-A included in the cloud service provider network 223 at phase 230-9. The cloud service provider 203-1, . . . , 203-A can accept the conditional purchase offer, as shown at phase 230-9, or the cloud service provider can reject the conditional purchase offer, as shown at phase 230-10.

During phase 230-11 the cloud broker network 222 can analyze and/or store responses, such as those from phase 230-9 and/or 230-10. For example, the cloud broker network 222 can store the responses in a data store (e.g., a database), such as those described herein, and/or provide the response to the customer network 221, as shown at phase 230-12, upon receipt of a response, upon request by a customer 225, and/or upon reaching an expiration date include in the conditional purchase offer. The response provided to the customer 225 at phase 230-12 can include transmitting an email to the customer 225, providing a notification via a GUI associated with the customer, and/or otherwise notifying the customer that a response has been received from a cloud service provider. During phase. 230-13 the response can be displayed to the customer 225, as described herein. A preferred service provider can be determined at phase 230-14, as described herein. Phase 230-14 can include providing payment information to a cloud broker network 222 and/or a cloud service provider 203-1, . . . , 203-A. While FIG. 2 illustrates a particular number of phases the present disclosure is not so limited. That is, an example of a flow diagram for conditionally purchasing cloud services can include more phases or fewer phases than those illustrated in FIG. 2.

FIG. 3 illustrates a diagram of an example of a system 340 for conditionally purchasing cloud services according to the present disclosure. The system 340 can include a data store 308 (e.g., analogous to data store 108 as referenced in FIG. 1), a conditional cloud service purchasing system 342, and/or a number of engines. The conditional cloud service purchasing system 342 can be in communication with the data store 308. The conditional cloud service purchasing system 342 can include a number of engines (e.g., an offer engine 343, a provide engine 344, a response engine, etc.). The conditional cloud service purchasing system 342 can include additional or fewer engines than illustrated to perform the various functions described herein.

The number of engines can include a combination of hardware and programming to perform a number of functions described herein (e.g., a provide engine provides the conditional purchase offer to a cloud service provider, etc.). Each of the engines can include hardware or a combination of hardware and programming designated or designed to execute a module (e.g., a particular module). The programming can include instructions (e.g., software, firmware, etc.) stored in a memory resource (e.g., computer-readable medium) as well as a hard-wired program (e.g., logic).

The offer engine 343 can receive a conditional purchase offer of a cloud service. The conditional purchase offer can include an offer price and/or service attributes, among other conditions associated with the cloud service. A conditional purchase offer refers to information that can serve as a contract between a customer and a cloud service provider upon (e.g., only upon) satisfaction of conditions included in the conditional purchase offer. That is, a cloud service provider acceptance of a conditional purchase offer includes acceptance of an offer price in the conditional purchase offer and acceptance of an agreement to satisfy conditions (e.g., service attributes, SLA parameters, etc.) included in the conditional purchase offer.

A provide engine 344 can provide the conditional purchase offer to a cloud service provider. A response engine 346 can receive a response to the conditional purchase offer, such as the conditional purchase offer provided by the provide engine 344.

Identifying information refers to information that can identify a particular conditional purchase offer, a particular cloud service, a particular response, and/or a particular cloud service provide, among others. Identifying information can include information pertaining to a category (e.g., a particular industry associated with a cloud service), a name, and/or an identifier, among other identifying information associated with a cloud service, a conditional purchase offer, etc. The identifying information can include information providing a timeframe (e.g., a time such as day, month, etc.) of which a conditional purchase offer was provided to a cloud service provider(s) and/or an expiration date of the conditional purchase offer, among other times/timeframes.

In some examples, a display engine (not shown) can cause a display, for example, cause a display of a response. In some examples, the display engine can cause a display (e.g., cause the display without a user request/user input), for example, a display of a status (e.g., “accepted”) associated with a conditional purchase offer. In various examples, the display engine can cause the display, via the GUI, of the information pertaining to a status of a conditional purchase offer and/or corresponding identifying information associated with the conditional purchase offer.

FIG. 4 illustrates a diagram of an example of a computing device for conditionally purchasing of cloud services according to the present disclosure. The computing device 455 can utilize software, hardware, firmware, and/or logic to perform a number of functions described herein.

For example, the computing device 455 can be a combination of hardware and instructions for business process management. The hardware, for example can include a processing resource 460 and/or a memory resource 464 (e.g., computer-readable medium (CRM), data store, etc.) A processing resource 460, as used herein, can include a number of processors capable of executing instructions stored by a memory resource 464. Processing resource 460 can be integrated in a single device or distributed across multiple devices. The instructions (e.g., computer-readable instructions (CRI)) can include instructions stored on the memory resource 464 and executable by the processing resource 460 to implement a desired function (e.g., receive a response from a cloud service provider, etc.).

The memory resource 464 can be in communication with a processing resource 460. A memory resource 464, as used herein, can include a number of memory components capable of storing instructions that can be executed by processing resource 460. Such memory resource 464 can be a non-transitory CRM. Memory resource 464 can be integrated in a single device or distributed across multiple devices. Further, memory resource 464 can be fully or partially integrated in the same device as processing resource 460 or it can be separate but accessible to that device and processing resource 460. Thus, it is noted that the computing device 455 can be implemented on a workstation and/or a collection of workstations, on a link (e.g., a cloud broker network) and/or a collection of links, and/or on a combination of the workstations and the links.

The memory resource 464 can be in communication with the processing resource 460 via a communication link (e.g., path) 462. The communication link 462 can be local or remote to a computing device associated with the processing resource 460. Examples of a local communication link 462 can include an electronic bus internal to a computing device where the memory resource 464 is one of volatile, non-volatile, fixed, and/or removable storage medium in communication with the processing resource 460 via the electronic bus.

The memory resource 464 can include a number of modules such as a provide module 466, a response module 468, a determine module 470, etc. The number of modules 466, 468, 470 can include CRI that when executed by the processing resource 460 can perform a number of functions. The number of modules 466, 468, 470 can be sub-modules of other modules. For example, the provide module 466 and the response module 468 can be sub-modules and/or contained within the same computing device. In another example, the number of modules 466, 468, 470 can comprise individual modules at separate and distinct locations (e.g., CRM, etc.).

Each of the number of modules 466, 468, 470 can include instructions that when executed by the processing resource 460 can function as a corresponding engine, including those as described herein. For example, the provide module 466 can include instructions that when executed by the processing resource 460 can function as the provide engine 344, for instance, to provides the conditional purchase offer to a cloud service provider. Similarly, the provide module 466 can the conditional purchase offer includes an offer price and/or SLA parameters associated with the cloud service, as described herein.

In some examples, the provide module 466 can provide include instructions to provide an alternative conditional purchase offer. The alternative conditional purchase offer can include a different purchase price, different SLA parameters, and/or different service attributes than those included in the conditional offer. The alternative conditional purchase offer can be provide along with (e.g., at substantially the same time) as the conditional purchase offer is provided to a service provider and/or can be provided at a different time than the conditional purchase offer to a service provider. For example, the alternative purchase offer can be provided in response to receipt of a rejection of the conditional purchase offer from a service provider. Similarly, the alternative purchase offer can, in some examples, be provided in response to receipt of rejections from each of a plurality of service providers and/or upon reaching an expiration date (e.g., immediately following an expiration date/time), as described herein, when no acceptances have been received from the plurality of services providers. In some examples, the conditional offer and the alternative conditional offer can each include a cloud service in a same category (e.g., SaaS) of cloud service.

A response module 468 can include instructions that when executed by the processing resource 460 can function as a response engine 346 to receive a response to a conditional purchase offer. The response can, in some examples, be included in a plurality of responses to the conditional purchase offer received from a plurality of cloud service providers. For example, the response engine 346 can receive, from a plurality of cloud service providers, a plurality of responses to the conditional purchase offer. The plurality of responses can, for example, include a plurality of acceptances or rejections of the conditional purchase offer and/or a plurality of rejections of the conditional purchase offer. The plurality of responses can be displayed, as described herein, in a manner to filter based on a geographic location of a cloud service provider. Such filtering can advantageously promote determining a preferred cloud service provider, for instance, a cloud service provider that submitted an acceptance of a conditional purchase offer and that is comparatively closest in geographic proximity to a customer.

In some examples, a comparatively lowest price offered for the cloud service can be provided along with a rejection. For example, a conditional purchase offer can include an offer price (e.g., $5000) that can be comparatively lower than a purchase price of a cloud service (e.g., $8000) such as a publically advertised purchase price and/or a purchase price communicated in a rejection of the condition purchase offer). Such a purchase price can be a comparatively lowest price of a plurality of purchase prices offered for a cloud service(s) provided by a plurality of cloud service providers that satisfies conditions included in a conditional purchase offer.

In some examples, payment information can be provided to a cloud service provider in response to receiving an acceptance. Payment information refers to information sufficient to provide a cloud service provider with payment for a cloud service, such as providing payment information to a cloud service provider that transmitted an acceptance in response to receipt of a conditional purchase offer for a cloud service. Examples of payment information include credit card information, bank account routing information, etc. that can provide a cloud service provider with a payment (e.g., a monetary amount). Payment information can be stored in a data store, such as data store 308.

For example, the payment information can be automatically provided (e.g., without a user input) to a preferred cloud service provider in response to receiving an acceptance. A preferred cloud service provider refers to a cloud service provider providing a cloud service that satisfies an offer price (e.g., an acceptance includes a purchase price that is less than or equal to the offer price included in the conditional service offer), satisfies service attributes (e.g., satisfies all mandatory service attributes), and/or satisfies SLA parameters (e.g., meets or exceeds all SLA parameters included in the conditional purchase offer). Thus, determining a preferred cloud service provider can include determining a cloud service provider based on a offer price, service attributes, and/or SLA parameters. However, the present disclosure is not so limited. That is, payment information can be provided to a cloud service provider upon authorization, as described herein, among other ways to promote conditionally purchasing cloud services. Advantageously, providing payment information in response to receiving an acceptance and/or upon authorization can promote ensure privacy of such payment information is maintained (e.g., in contrast to approaches that may transmit payment information along with a condition purchase offer for a good or service).

In some examples, a conditional purchase offer can include SLA parameters, for instance, an uptime parameter. Examples of SLA parameters can include an uptime parameter (e.g., a percentage of time over a span of time in which a cloud service is available for use by a customer of the cloud service), an average file retrieval time, among other SLA parameters.

A conditional purchase offer can, in some examples, include an expiration date. An expiration date refers to a date and/or time at which a conditional purchase offer that include the expiration date expires. That is, responses to the conditional purchase offer can be received (e.g., only can be received) if made prior to reaching the expiration date. For example, multiple responses can be received prior to the expiration date and are only displayed or otherwise communicated to a customer (e.g., perspective customer) of a cloud service when the expiration date is reached. That is, a response to a purchase offer including an expiration date cannot be provided after the expiration date has been reached. Similarly, a preferred cloud service provider can, in some examples, only be determined only once an expiration date is reached. However, the present disclosure is not so limited. That is, a response to a conditional purchase offer including an expiration date can be communicated to a customer prior to, upon reaching, or after an expiration date included in the conditional purchase offer.

In some examples, a cloud service provider can include an expiration date in a response to a conditional purchase offer. For example, a cloud service provider providing a response to a conditional purchase offer can include an expiration date. The response can be authorized prior to reaching the expiration date or the response can become void (e.g., the acceptance can no longer be authorized and/or payment information can no longer be authorized for the acceptance). For instance, a response including an expiration date that is reached may be automatically deleted (e.g., deleted by a cloud broker) or otherwise prohibited (e.g., removed) from display to a customer. In some examples, an attempted authorization of a response including an expiration date that has been reached can be denied (e.g., deleted/not communicated to a cloud provider) by a cloud broker.

The determine module 470 can include instructions that when executed by the processing resource 460 can function as a determine engine (not shown) to determine a preferred cloud service provider from the plurality of cloud service providers based on the offer price and/or the SLA parameters included in the conditional purchase offer, as described herein. A preferred cloud service provider, as discussed herein, can be determined from the plurality of acceptances of the conditional purchase offer.

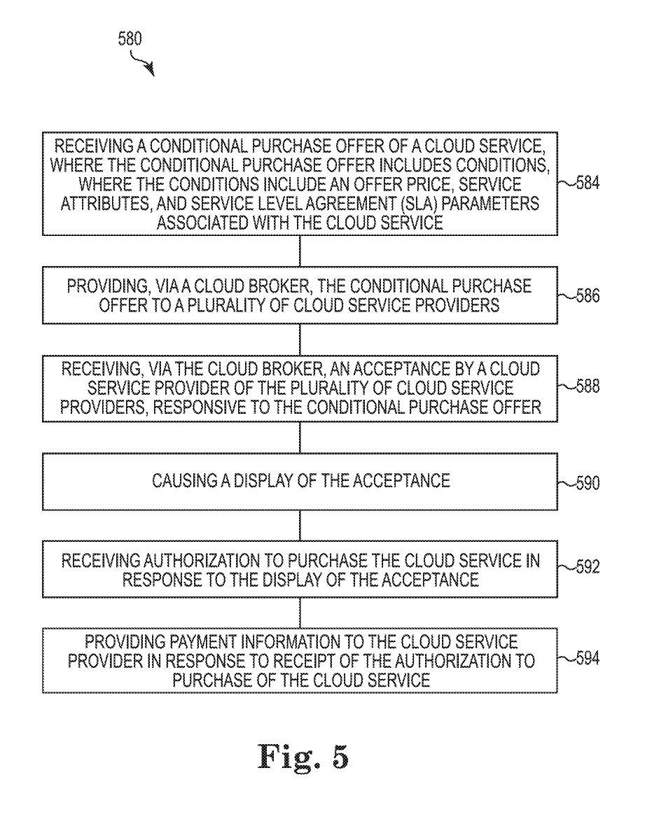

FIG. 5 illustrates a flow diagram of an example of a method for conditionally purchasing cloud services according to the present disclosure. As shown at block 584, in various examples, the method 580 can include receiving a conditional purchase offer of a cloud service. The conditional purchase offer can include conditions such as an offer price, service attributes, and/or SLA parameters associated with the cloud service, as described herein.

As shown at block 586, the method 580 can include providing, via a cloud broker, such as those described herein, the conditional purchase offer, for example as described at 584, to a plurality of cloud service providers. In various examples, the method 580 can include, receiving, via the cloud broker, an acceptance by a cloud service provider of the plurality of cloud service providers, responsive to the conditional purchase offer, as shown at block 588.

The method 580, as shown a block 590, can include causing a display of the acceptance, as described herein. For example, an acceptance can be displayed in response to a cloud service provider transmitting the acceptance and/or a cloud broker receiving the acceptance or an acceptance can be displayed when an expiration date of a conditional offer to which the acceptance is responsive to is reached, among others displays of an acceptance to promote conditionally purchasing cloud services.

As shown at block 592, the method 580 can include receiving authorization to purchase the cloud service in response to the display of the acceptance, for example as described at 590. Advantageously, causing a display and/or receiving authorization to purchase the cloud service can enable comparison of a plurality of acceptances of the conditional purchase offer. Such a comparison can be automatic, for example, based upon the purchase price, service attributes, and/or SLA parameters associated with each of the respective plurality of acceptances relative to an offer price, service attributes, and/or SLA parameters included in the conditional purchase offer. However, such a comparison can, in some examples, be performed by a customer based upon display of the plurality of acceptances (e.g., to a display caused on a computing device associated with the customer).

The method 580 can include providing payment information to the cloud service provider in response to receipt of the authorization to purchase of the cloud service, as shown at block 594. In some examples, payment information can be provided automatically, for example, in response to receipt of the authorization. Providing payment information automatically can result in automatically paying of an amount equal to the offer price to the cloud service provider. Such automatic payment can advantageously promote quick, reliable payment from a customer to a cloud service provider and/or promote timely delivery of cloud services to a customer, among other advantages.

In some examples, the method 580 can include displaying an electronic representation indicative of a status of a conditional purchase offer (e.g., accepted, pending, rejected, expired, etc.) and/or a status of a cloud service (e.g., a status of a cloud service to which a condition purchase offer has been provided), among other items. Such a display can be displayed via a UI. The UI (not shown) can be displayed via a display of a workstations (e.g., workstation 110-2), for example in response to receipt of a response, as described herein. The UI can include a plurality of electronic representations (not shown), a plurality of names and/or a plurality of statuses corresponding to a plurality of cloud service providers, plurality of cloud services offered by the plurality of cloud service providers, among other displayed items included in the UI. For example, a UI can simultaneously display a plurality of responses (e.g., a plurality of acceptances) and/or plurality of cloud services associated with the plurality of responses (e.g., a respective purchase price, service attributes, etc.), however, the present disclosure is not so limited. Rather, the displayed items (e.g., the a plurality of electronic representations, etc.) can be varied and/or include more of less displayed items to conditionally purchasing cloud services, as described herein

The plurality of electronic representations can each have functionality (e.g., a respective functionality) associated therewith. For example, selection of an electronic representation may cause the UI to perform an action (e.g., display a drop down menu, display a free text area, display a drill down menu, and/or cause an application utilizing the UI to perform a function). That is, the plurality of electronic representations and/or a plurality of statuses can facilitate a user to interact with the UI (e.g., provide an input to cause the UI to perform the functionality). For example, displaying the electronic representation can include causing a display of the acceptance and/or receiving authorization to purchase the cloud service in response to the display of the acceptance.

In some examples, displaying can include causing a simultaneous display of a plurality of electronic representations indicative of respective statuses associated with each of a plurality of cloud services. A simultaneous display refers to displaying the statuses of a plurality of cloud services and/or a conditional offer(s) for a cloud service(s) at the same time via an individual device (e.g., a single GUI of the individual device). For example, a plurality of responses can be received and each of the plurality of responses can be displayed via a GUI. In some examples, a preferred service provider, as described herein, can be determined from the plurality of responses displayed via the GUI. The plurality of response can be received in response to a conditional purchase offer of a cloud service and/or an alternative conditional purchase offer.

Causing can include executing instructions stored in memory to directly cause a computing device to display, for example, electronic representations, indicative of an acceptance by a cloud service provider responsive to a conditional purchase offer and/or to communicate data with an expectation that it be processed by another device to cause the computing device to display the electronic representations, for example, those indicative of an acceptance by a cloud service provider responsive to a conditional purchase offer. Similarly, blocks 584, 586, 588, 590, 592, 594 can include executing instructions, for example, as described with regard to the engines herein, stored in memory to perform the examples of the method described therein.

As used herein, “logic” is an alternative or additional processing resource to execute the actions and/or functions, etc., described herein, which includes hardware (e.g., various forms of transistor logic, application specific integrated circuits (ASICs), etc.), as opposed to computer executable instructions (e.g., software, firmware, etc.) stored in memory and executable by a processing resource. The figures herein follow a numbering convention in which the first digit or digits correspond to the drawing figure number and the remaining digits identify an element or component in the drawing. Similar elements or components between different figures may be identified by the use of similar digits. For example, 108 may reference element “08” in FIG. 1, and a similar element may be referenced as 308 in FIG. 3.

In the detailed description of the present disclosure, reference is made to the accompanying drawings that form a part hereof, and in which is shown by way of illustration how examples of the present disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the present disclosure.

As will be appreciated, elements shown in the various examples herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense. As used herein, “a number of” an element and/or feature can refer to a number of such elements and/or features. In addition, “for example” and similar phrasing is intended to mean. “by way of example and not by way of limitation”.

The specification examples provide a description of the applications and use of the system and method of the present disclosure. Since many examples can be made without departing from the spirit and scope of the system and method of the present disclosure, this specification sets forth some of the many possible example configurations and implementations.

What is claimed:

1. A system for conditionally purchasing cloud services, comprising a processing resource in communication with a non-transitory computer readable medium having instructions executable by the processing resource to implement an offer engine, a provide engine, and a response engine, wherein:
the offer engine receives a conditional purchase offer of a cloud service, wherein the conditional purchase offer includes an offer price and service attributes associated with the cloud service;
the provide engine provides the conditional purchase offer to a cloud service provider; and
the response engine receives a response to the conditional purchase offer.

2. The system of claim 1, wherein the response is included in a plurality of responses to the conditional purchase offer received from a plurality of cloud service providers.

3. The system of claim 2, including determining a preferred cloud service provider based on the service attributes included in the conditional purchase offer.

4. The system of claim 1, wherein the response includes an acceptance of the conditional purchase offer, and wherein payment information is provided to a cloud service provider in response to receiving the acceptance.

5. The system of claim 1, wherein the response includes an acceptance of the conditional purchased offer, wherein the acceptance includes an expiration date, and wherein the acceptance becomes void upon reaching the expiration date.

6. The system of claim 1, wherein the conditional purchase offer includes service level agreement (SLA) parameters that include an uptime parameter.

7. The system of the claim 1, wherein the conditional purchase offer includes an expiration date.

8. The system of claim 1, wherein the service attributes associated with the cloud service include elective service attributes.

9. A non-transitory computer-readable medium storing instructions executable by a processing resource to:
provide a conditional purchase offer of a cloud service to a plurality of cloud service providers, wherein the conditional purchase offer includes an offer price and service level agreement (SLA) parameters associated with the cloud service;
receive, from the plurality of cloud service providers, a plurality of responses to the conditional purchase offer; and
determine a preferred cloud service provider from the plurality of cloud service providers based on the offer price and the SLA parameters included in the conditional purchase offer.

10. The medium of claim 9, wherein the instructions to provide include instructions to provide an alternative conditional purchase offer, wherein the alternative conditional purchase offer includes SLA parameters that are different from the SLA parameters included in the conditional purchase offer.

11. The medium of claim 10, wherein the alternative conditional offer is provided to the plurality of cloud service providers along with the conditional purchase offer.

12. The medium of claim 10, wherein the conditional offer and the alternative conditional offer each include the cloud service in a same category of cloud service.

13. The medium of claim 9, wherein the instructions include instructions to display each of the plurality of responses via a graphical user interface (GUI), and wherein the preferred service provider is determined from the plurality of responses displayed via the GUI.

14. A method for conditionally purchasing of cloud services, comprising:
receiving a conditional purchase offer of a cloud service, wherein the conditional purchase offer includes conditions, wherein the conditions include an offer price, service attributes, and service level agreement (SLA) parameters associated with the cloud service;
providing, via a cloud broker, the conditional purchase offer to a plurality of cloud service providers;
receiving, via the cloud broker, an acceptance by a cloud service provider of the plurality of cloud service providers, responsive to the conditional purchase offer;
causing a display of the acceptance;
receiving authorization to purchase the cloud service in response to the display of the acceptance; and
providing payment information to the cloud service provider in response to receipt of the authorization to purchase of the cloud service.

15. The method of claim 14, wherein the payment information is provided automatically in response to receipt of the authorization and results in automatically paying of an amount equal to the offer price to the cloud service provider.
